(19) United States
(12) Patent Application Publication
(10) Pub. No.: US 2013/0293924 A1
(43) Pub. Date: Nov. 7, 2013

(54) SYSTEMS AND METHODS FOR EMBEDDING CONSTRAINT LOGIC OF PRINT SETTINGS IN PRINT CAPABILITIES

(71) Applicants: Charles Thomas Armstrong, Rancho Santa Margarita, CA (US); Chihsin Steven Young, Irvine, CA (US)

(72) Inventors: Charles Thomas Armstrong, Rancho Santa Margarita, CA (US); Chihsin Steven Young, Irvine, CA (US)

(73) Assignee: CANON KABUSHIKI KAISHA, Tokyo (JP)

(21) Appl. No.: 13/464,335

(22) Filed: May 4, 2012

(51) Int. Cl. G06K 15/02

(52) U.S. Cl. 358/1.15

(57) ABSTRACT

Systems and methods for updating print data receive a request for print capabilities data from a computing device, wherein the request includes print settings data, and wherein the print settings data indicates a first imaging device associated with the print settings data; generate print capabilities data based on the print settings data and on printing capabilities of the first imaging device; add imaging device capability constraint logic for the first imaging device to the print capabilities data, and send the print capabilities data to the computing device.

### BACKGROUND

1. Field of the Disclosure

The present disclosure relates generally to systems and methods for embedding constraint logic of print settings in print capabilities data.

2. Description of the Related Art

In the field of print processing, it is a challenging task for Independent Software Vendors (also referred to herein as “ISVs”) to provide a consistent user interface for receiving a desired print intent from a user while supporting private settings for the printers of multiple Independent Hardware Vendors (also referred to herein as “IHVs”). The communication between the Windows® print sub system, an IHV's plug-in driver, and an ISV's application causes part of the difficulties, because the communication is done thru indexed based binary DevMode structures (also referred to herein as “DevMode”) and binary DevCaps structures (also referred to herein as “DevCaps”).

Microsoft® introduced a new XML based print schema to address the problems associated with communication between the print subsystem and external applications. The print schema technology uses an XML based public schema to describe printer capabilities, device configurations, and job formatting settings. Applications can use the XML based schema to provide print dialogs to change print settings.

### SUMMARY OF THE INVENTION

In one embodiment, a method for printing comprises receiving a request for print capabilities data from a computing device, wherein the request includes print settings data, and wherein the print settings data indicates a first imaging device associated with the print settings data, generating print capabilities data based on the print settings data and on printing capabilities of the first imaging device, adding imaging device capability constraint logic for the first imaging device to the print capabilities data, and sending the print capabilities data to the computing device.

In one embodiment, one or more computer-readable media store computer-executable instructions that, when executed by one or more computing devices, cause the one or more computing devices to perform operations comprising receiving print settings data for a first imaging device, generating print capabilities data based on the print settings data and on print capabilities of the first imaging device, and adding imaging device capability constraint logic for the first imaging device to the print capabilities data.

In one embodiment, a computing device for updating print settings comprises a computer-readable medium; and one or more processors configured to cause the computing device to receive print settings data for a print job for an imaging device, generate print capabilities data for the print job based on the print settings data and print capabilities of the imaging device, and add imaging device capability constraint logic to the print capabilities data, wherein the imaging device capability constraint logic indicates a relationship between print capabilities for a print setting and print capabilities for another print setting.

### BRIEF DESCRIPTION OF THE DRAWINGS

FIG. 1 is a block diagram illustrating an embodiment of a printing system.

FIG. 2 is a flowchart illustrating an embodiment of a method for embedding a constraint logic handler object inside print capabilities data.

FIG. 3 is a flowchart illustrating an embodiment of a method for generating a user interface.

FIG. 4 is a flowchart illustrating an embodiment of a method for updating a user interface.

FIG. 5 illustrates an example embodiment of a user interface.

FIG. 6 illustrates an example embodiment of a user interface.

FIG. 7 illustrates an example embodiment of a user interface.

FIG. 8 illustrates an example embodiment of a constraint logic entry.

### DETAILED DESCRIPTION OF CERTAIN EMBODIMENTS

The following disclosure describes certain illustrative embodiments. Additionally, the illustrative embodiments may include several novel features, and a particular feature may not be essential to practice all the embodiments of the systems and methods described herein.

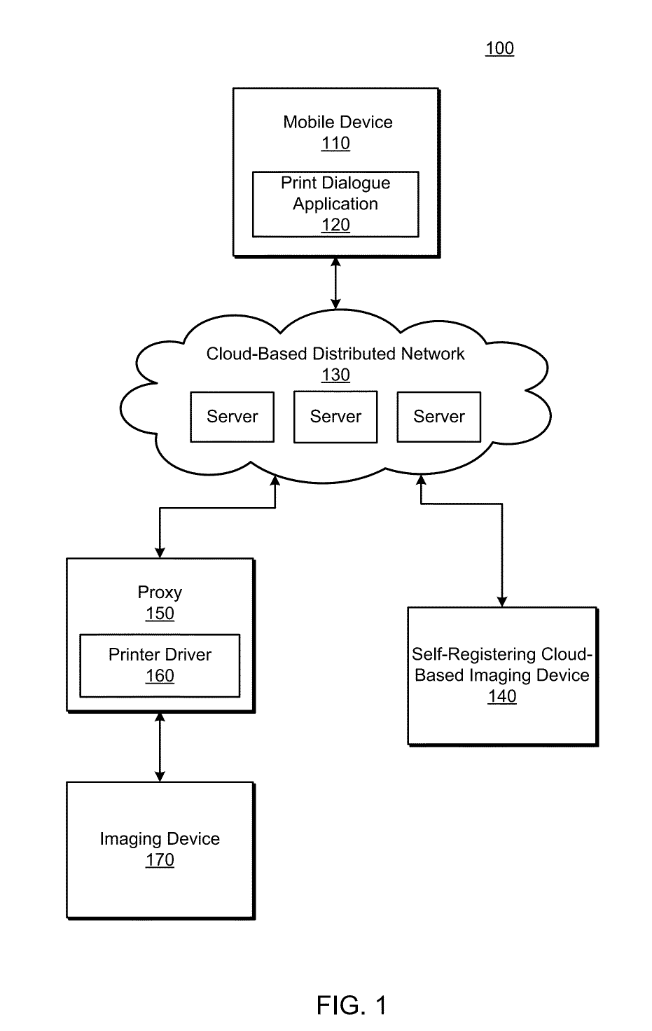

FIG. 1 is a block diagram illustrating an embodiment of a printing system 100. The printing system 100 includes a mobile device 110, a cloud-based distributed network 130, a self-registering cloud-based imaging device 140, a proxy 150 and an imaging device 170. The entities in the printing system 100 may communicate via wired or wireless channels.

The mobile device 110 may be a mobile phone, a personal digital assistant (PDA), or a tablet, which is capable of communicating via a network and/or may include at least one display that is capable of rendering images. In other embodiments, another computing device (e.g., any computing device, such as a desktop, laptop computer, server) may be used instead of the mobile device 110. The mobile device 110 includes one or more processors (also referred to herein as “CPUs”), which may be a conventional or customized microprocessor(s). The CPUs are configured to read and execute computer-readable instructions, and the CPUs may command and/or control other components of the mobile device 110.

The mobile device 110 also includes I/O interfaces and/or I/O devices. The I/O interfaces provide communication interfaces to I/O devices, and the I/O devices may include a keyboard, a display device, a mouse, a printing device, a touch screen, a light pen, an optical storage device, a scanner, a microphone, a camera, etc. The mobile device 110 also includes memory, which may be volatile or non-volatile, such as ROM, RAM, and flash memory. The mobile device 110 further includes a network interface that allows the mobile device 110 to communicate with the other devices (e.g., the cloud-based distributed network 130). The mobile device 110 also includes a storage device that is configured to store data or modules and may include, for example, a hard drive, an optical storage device, a diskette, and a solid state drive. The mobile device 110 includes an operating system, which manages the hardware, the processes, the interrupts, the memory, and/or the file system of the mobile device 110.

The mobile device 110 further includes a print dialogue application 120. The print dialogue application 120 generates a user interface that presents information to a user and/or receives information from the user via the mobile device 110. The user interface may present the information in the form of a graphical interface that shows printer settings and capabilities and that receives user selections, such as selections of one or more options for a respective setting. The information may also be presented in any other manner that allows the user to view the information and/or select one or more options. Further, the print dialogue application 120 may be any application that prints data, such as a document processing application or a web browser.

The self-registering cloud-based imaging device 140 and the legacy imaging device 170 are both configured to receive data and print images (e.g., text, graphics, photographs) on one or more print media (e.g., paper, cardboard, plastic) based on the received data. Additionally, the self-registering cloud-based imaging device 140 and the imaging device 170 may print the images onto the print media according to one or more user adjustable settings. Furthermore, the self-registering cloud-based imaging device 140 does not require an intermediary device (e.g., a proxy) to communicate with the cloud-based distributed network 130. That is, the self-registering cloud-based imaging device 140 communicates directly with the cloud-based distributed network 130. The self-registering cloud-based imaging device 140, which may also include a printer driver, is configured to communicate via a network and automatically register itself with the cloud-based distributed network 130, for example upon initial activation or in response to a user command (e.g., a button activation). In contrast, the imaging device 170 requires an intermediary device, such as the proxy 150, to communicate with the cloud-based distributed network 130. That is, the imaging device 170 communicates indirectly with the cloud-based distributed network 130 via the proxy 150.

The cloud-based distributed network 130 includes one or more servers that may store and/or provide data and/or other information. For example, the servers in the cloud-based distributed network 130 may be cloud printing service servers (e.g., Google® Cloud Print) or independent hardware vendor (IHV) servers.

The proxy 150 is a computing device that interfaces between one or more entities and one or more other entities in a network. Particularly in the disclosed embodiments, the proxy 150 is configured to relay data between the cloud-based distributed network 130 and the imaging device 170 and/or relay data between the cloud-based distributed network 130 and a printer driver 160. When relaying data, the proxy 150 may change the format of the data (e.g., the protocol, the language). In addition, the proxy 150 may invoke the functionality of the printer driver 160 via an option, may send data to the printer driver 160 in the form of parameters of the option, and may receive the data (if any) returned by the option. Furthermore, in one embodiment the proxy 150 includes the printer driver 160.

The printer driver 160 is configured to receive data, perform requested operations, and return requested data (e.g., to the proxy 150). Moreover, the printer driver 160 is configured to communicate with the imaging device 170 regarding the settings, capabilities, and status of the imaging device 170 (e.g., paper level, ink level, toner level, paper size, colors).

Settings include, but are not limited to, media size, borderless printing, duplexing, media type, resolution, colors, orientation, copying, collating, media quality, print quality, and margins. An option defines a configuration for a setting (e.g., gray scale is an option for color, letter size is an option for media size, landscape is an option for orientation), and a set of some or all of the available options for a setting are the capabilities of the respective setting (e.g., portrait and landscape may be the capabilities for orientation). Constraint logic maps the relationships between the settings, capabilities, and the selected settings options of an imaging device. In detail, the constraint logic indicates the relationship between selected options, constrained options, and/or options to be excluded from the print capabilities. Thus, the constraint logic indicates which options are constrained for a setting based on the selected options for one or more other settings. For example, the constraint logic may indicate that when the option “on” is selected for the duplex printing setting, then the selected option for the borderless printing setting is constrained to be “off”.

Further, the printer driver 160 is configured with the constraint logic. Thus, the printer driver 160 may utilize the constraint logic to determine the print capabilities (e.g., which options are or are not available) based on the selected options of one or more settings of the imaging device 170, which includes determining which setting options are constrained based on the selected options of one or more other settings.

In one embodiment, the imaging device 170 is registered with at least one of the servers in the cloud-based distributed network 130, such as the cloud printing service server, via the proxy 150. Registration includes sending default print capabilities of the imaging device 170 to the cloud-based distributed network 130. For example, the imaging device 170 connects to the cloud-based distributed network 130 via the proxy 150. Then the proxy 150 sends to the printer driver 160 default print settings data, which indicates pre-selected settings options for the imaging device 170. The default print settings data may include data in the form of markup language data, for example an input PrintTicket XML document/object. The default print settings data may be sent to the printer driver 160 in a request for corresponding print capabilities data, which describes the capabilities of the imaging device when the imaging device is configured according to the default print settings data. Further, the print capabilities data may include a PrintCapabilities XML document/object or other markup language data. Accordingly, in response to receiving the default print settings data, the printer driver 160 sends the corresponding print capabilities data to the proxy 150. Then the proxy 150 sends the print capabilities data to the cloud-based distributed network 130. Thereupon, at least one of the servers in the cloud-based distributed network 130 stores the received print capabilities data, and the registration of the imaging device 170 is completed.

When the print dialogue application 120 is opened, the print dialogue application 120 communicates with at least one server in the cloud-based distributed network 130 to retrieve and display imaging device information (e.g., settings and capabilities). Then a user may select necessary print settings to fulfill his/her printing intent. Further details are described hereinafter.

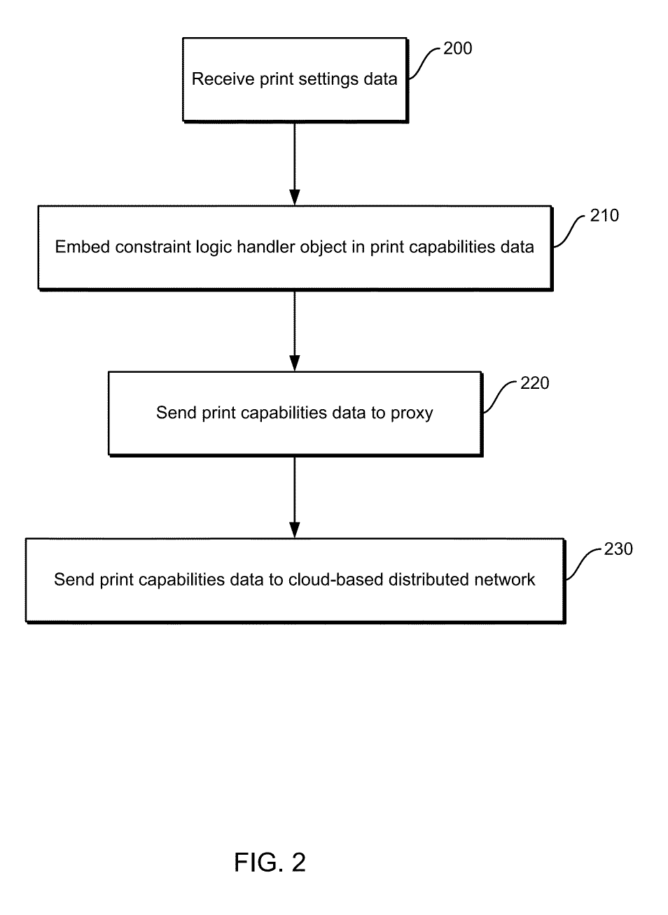

FIG. 2 is a flowchart illustrating an embodiment of a method for embedding a constraint logic handler object inside print capabilities data. As mentioned above, when the imaging device 170 is registered to one of the servers (e.g., cloud printing service server) in the cloud-based distributed network 130 via the proxy 150, the proxy 150 sends print settings data (e.g., default print settings data) to the printer driver 160.

Beginning in block 200, the print settings data (e.g., a PrintTicket document) is received at the printer driver (e.g., the printer driver 160). The print settings data includes an option that, when executed, prompts the printer driver 160 to embed a constraint logic handler object of the print settings in print capabilities data (e.g., a PrintCapabilities document). The constraint logic handler object may implement an application programming interface (API), such as a script (e.g., JavaScript), a REST API (e.g., representational state transfer API), or any other Web Service API, for calling the constraint logic of the print settings.

In block 210, the printer driver 160 embeds the constraint logic handler object in the print capabilities data according to the option included in the print settings data. The following is an example of the option included in the print settings data for calling a function to embed the constraint logic handler object as a scripting code (e.g., JavaScript) inside the print capabilities data:

<psf:Option name=“ns0000:EmbeddedAsScript”/>

In this case, the constraint logic of the print settings is included in the constraint logic handler object as scripting code fragment.

In another embodiment, the option for calling a function to embed the constraint logic handler object as a Web Service API (e.g., REST API) inside the print capabilities data utilizes the following option:

<psf:Option name=“ns0000:EmbeddedAsRESTAPI”/>

In this case, a print schema property value element is included in the constraint logic handler object to describe the REST API definition for retrieving the constraint logic of the print settings.

Yet in another embodiment, the option may call a function to not embed the constraint logic handler object inside the print capabilities data. In this case, the following option may be utilized:

<psf:Option name=“ns0000:None”/>

Next, in block 220, the printer driver 160 sends (e.g., returns) to the proxy 150 the print capabilities data that includes the constraint logic handler object specified in the print settings data. Finally, in block 230, the proxy 150 sends the print capabilities data, with the constraint logic handler object, received from the printer driver 160 to the cloud-based distributed network 130.

The above mentioned FIG. 2 has been described with respect to embodiments in which the imaging device is not a self-registering cloud-based imaging device 140. However, in a case where the imaging device is the self-registering cloud-based imaging device 140 that does not require an intermediary (e.g., proxy), the self-registering cloud-based imaging device 140 itself provides to the cloud-based distributed network 130 the default print settings and/or capabilities data (e.g., PrintTicket/PrintCapabilities documents) that include the constraint logic handler object. For example, in some embodiments, when the self-registering cloud-based imaging device 140 registers itself with the cloud-based distributed network 130, the self-registering cloud-based imaging device 140 sends default print capabilities data that includes the constraint logic handler object and sends the associated default print settings that correspond to the default print capabilities data (e.g., the print settings used to determine the print capabilities).

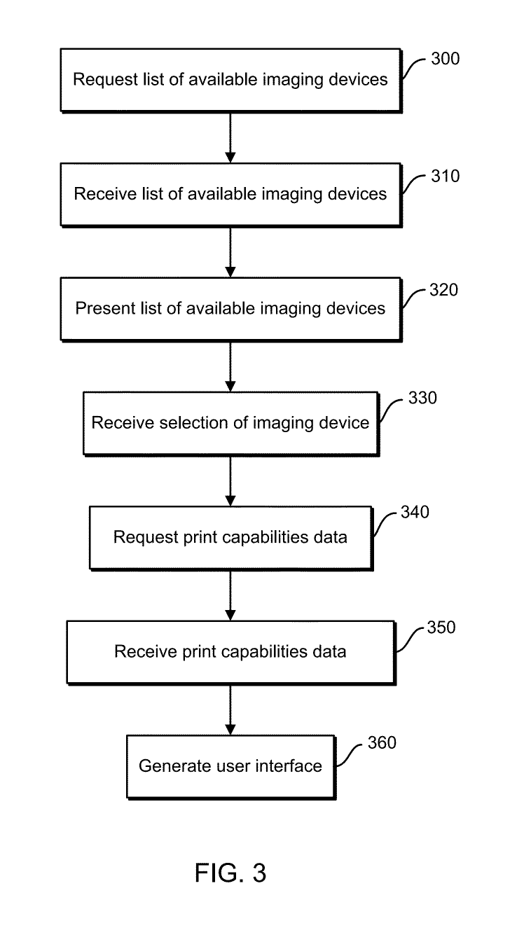

FIG. 3 is a flowchart illustrating an embodiment of a method for generating a user interface. Beginning in block 300, a request to retrieve a list of available imaging devices is sent to the cloud-based distributed network 130. For example, a mobile device 110 opens a print dialogue application 120. Then the print dialogue application 120 sends a request to the cloud-based distributed network 130 for a list of available imaging devices to which the user may send a print job.

In block 310, the requested list of available imaging devices is received by the print dialogue application 120. For example, upon receiving the request for a list of available imaging devices, the cloud-based distributed network 130 generates and returns the list of available imaging devices to the print dialogue application 120. The list may be generated based on the imaging devices that are registered with the cloud-based distributed network 130, and respective print capabilities data may be stored for the registered imaging devices (e.g., print capabilities data acquired as part of the registration).

Next, in block 320, the list of available imaging devices is presented. For example, when the print dialogue application 120 receives the returned list of available imaging devices, the print dialogue application 120 generates a user interface (e.g., a graphical user interface) that includes the list of available imaging devices, and the user interface is displayed to the user (e.g., by a display of the mobile device 110).

Moving to block 330, the selection of an imaging device from the list of available imaging devices is received by the print dialogue application 120. For example, when the list of available imaging devices is presented via the user interface generated by the print dialogue application 120, the user selects an imaging device to which the user desires to print from the list of available imaging devices.

Next, in block 340, a request for print capabilities data for the selected imaging device is sent to the cloud-based distributed network 130. For example, when the print dialogue application 120 receives the selection of an imaging device from the user, the print dialogue application 120 sends a request for the print capabilities data corresponding to the selected imaging device to the cloud-based distributed network 130.

Proceeding to block 350, the print dialogue application 120 receives the requested print capabilities data of the imaging device from the cloud-based distributed network 130. For example, when the cloud-based distributed network 130 receives the request for the print capabilities data of the selected imaging device from the print dialogue application 120, the cloud-based distributed network 130 returns the corresponding print capabilities data, which includes a constraint logic handler object, to the print dialogue application 120. The cloud-based distributed network 130 may store the print capabilities data prior to receiving the request, or the cloud-based distributed network may acquire the print capabilities data from a printer driver or a self-registering cloud-based imaging device after receiving the request.

In block 360, the print dialogue application 120 generates a user interface that displays the available and the selected print settings options of the selected imaging device based on the obtained print capabilities data. For example, when the print dialogue application 120 receives the print capabilities data from the cloud-based distributed network 130, the print dialogue application 120 generates a user interface for displaying the available and the selected print settings options, and a display presents the user interface to the user. Additionally, the print dialogue application 120 has also received the constraint logic handler object and may use the constraint logic handler object to update the user interface or generate another user interface.

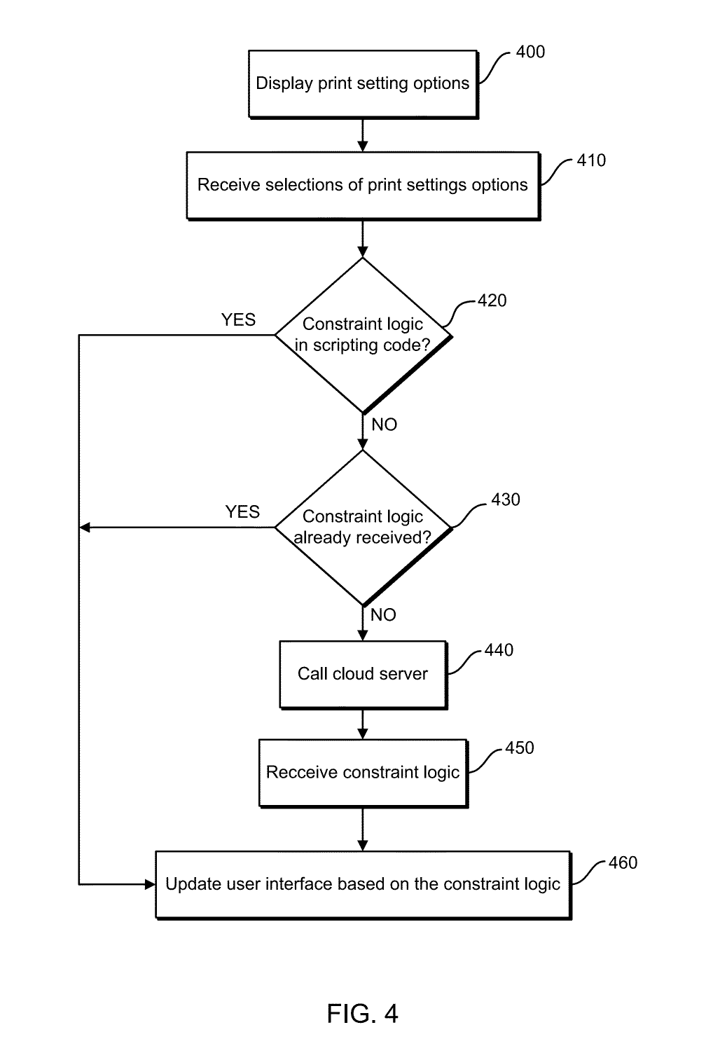

FIG. 4 is a flowchart illustrating an embodiment of a method for updating a print user interface. First, in block 400, the print settings options are displayed via a user interface. For example, the print dialogue application 120 generates a user interface that presents the default and the available print settings options of a user-selected imaging device to the user.

In block 410, the user selects print settings options via the user interface. For example, the user selects a print setting (e.g., paper size, media type) and modifies the associated print setting option (e.g., legal, letter, A4, plain paper, cardstock, photo paper) presented by the user interface.

Next, in block 420, the print dialogue application 120 determines if constraint logic has already been received. If the constraint logic is determined to have been received (YES), flow proceeds to block 450. For example, when the constraint logic handler object implements a scripting code (e.g., JavaScript) that includes a scripting code fragment of constraint logic, the print dialogue application 120 updates the user interface based on the scripting code. Therefore, the print dialogue application 120 determines that the constraint logic has already been received.

If the constraint logic is determined to have not received (NO), flow proceeds to block 430, where the print dialogue application 120 calls a server (e.g., a cloud print service server) in the cloud-based distributed network 130 to obtain the constraint logic of the selected print settings. In detail, the print dialogue application 120 calls a server in the cloud-based distributed network 130 and passes parameters requesting constraint logic of the selected print settings. For example, the parameters may include a command to embed constraint logic inside print capabilities data, and the parameters may be sent to the server in print settings data, which describes the selected print settings options in markup language data, such as a PrintTicket document/object. Then according to the parameters, the cloud printing service server calls an independent hardware vendor cloud server (which may be indicated by the parameters) via the cloud-based distributed network 130. However, the server which the cloud printing service server calls is not limited to the independent hardware vendor (IHV) cloud service server. It may be any cloud server that is configured to provide the constraint logic of the selected imaging device.

Moving to block 440, the constraint logic of the selected print settings is received by the print dialogue application 120. In detail, the independent hardware vendor cloud server returns constraint logic to the cloud printing service server. Then the cloud printing service server passes the constraint logic to the print dialogue application 120. In some embodiments, the cloud printing service server already stores the constraint logic and returns the constraint logic to the print dialogue application 120 without calling another server. Additionally, the cloud printing service may acquire the constraint logic from a printer driver, for example as described in the embodiment of FIG. 2.

Finally, in block 450, the user interface of the print settings and print capabilities is updated based on the received constraint logic. For example, the print dialogue application 120 implements the received constraint logic based on the selected print settings options to determine which print settings options are constrained and which print settings options are available to be selected. Thus, the user interface that displays the print settings and the print capabilities is updated.

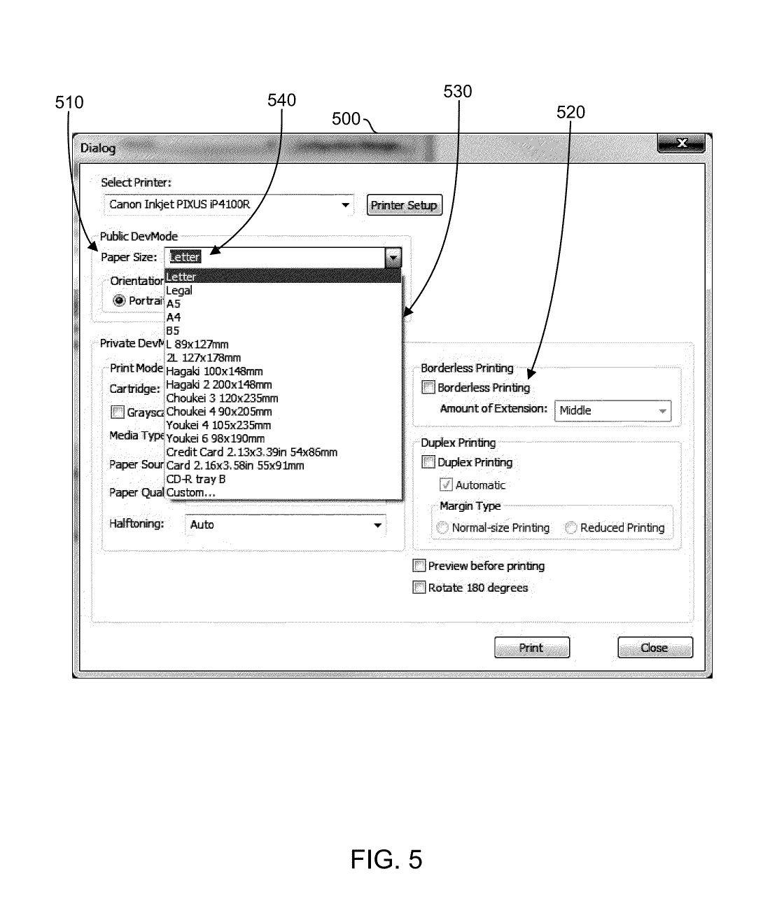

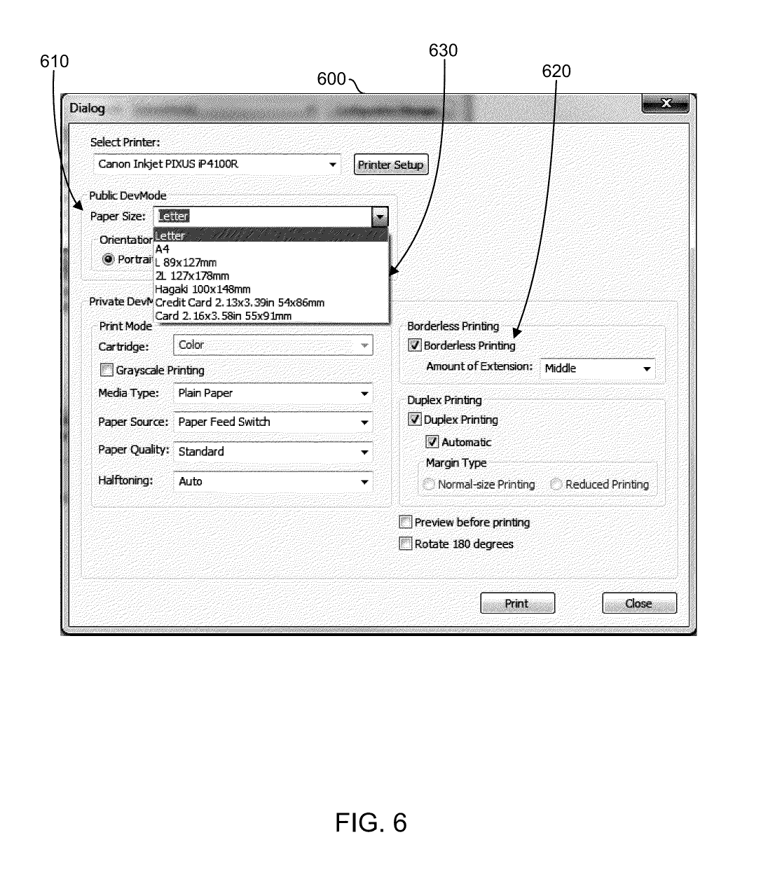

FIG. 5 illustrates an example embodiment of a user interface. The user interface 500 includes a plurality of settings, which include paper size 510, orientation, print mode, grayscale, media type, paper source, paper quality, halftoning, borderless printing 520, duplex printing, margin type, and rotate 180 degrees. The user interface 500 displays the capabilities 530 for the paper size 510 and the selected option 540 (Letter) of the paper size 510. When the options for the settings are set as shown by the user interface 500, the capabilities 530 for the paper size 510 include Letter, Legal, A5, A4, B5, etc. Thus, when the option for borderless printing 520 is set to “off,” the capabilities 530 for the paper size 510 are as shown in the user interface 500. However, if borderless printing 520 is set to “on” and borderless printing 520 has a higher priority than paper size 510, then the capabilities 530 for the paper size 510 change, as discussed below in reference to FIG. 6.

FIG. 6 illustrates an example embodiment of a user interface 600, which shows the capabilities 630 of the paper size 610 when borderless printing 620 is set to “on” and has a higher priority than paper size 610. The capabilities 630 now provide seven options: Letter, A4, L 89×127 mm, 2L 127×178 mm, Hagaki 100×148 mm, Credit Card 2.13×3.39 in 54×86 mm, and Card 2.16×3.58 in 55×91 mm.

Therefore, in this embodiment, if the print settings data indicates that the initially selected option for borderless printing is “off,” the print capabilities data generated based on the print settings data will indicate that the capabilities for the paper size setting are Letter, Legal, A5, A4, B5, L 89×127 mm, 2L 127×178 mm, Hagaki 100×148 mm, Hagaki 2 200×148 mm, Choukei 3 120×235 mm, Choukei 4 90×205 mm, Youkei 4 105×235 mm, Youkei 6 98×190 mm, Credit Card 2.13×3.39 in 54×86 mm, Card 2.16×3.58 in 55×91 mm, CD-R tray B, and Custom. If a user sets borderless printing to “on” via the user interface, print settings data is generated that indicates that the option for borderless printing is changed to “on.” The corresponding updated print capabilities indicate that the print capabilities for the paper size are Letter, A4, L 89×127 mm, 2L 127×178 mm, Hagaki 100×148 mm, Credit Card 2.13×3.39 in 54×86 mm, and Card 2.16×3.58 in 55×91 mm. The relationship between the paper size and borderless printing is an example of the relationships (between selected print settings options and print capabilities) that may be described by the constraint logic.

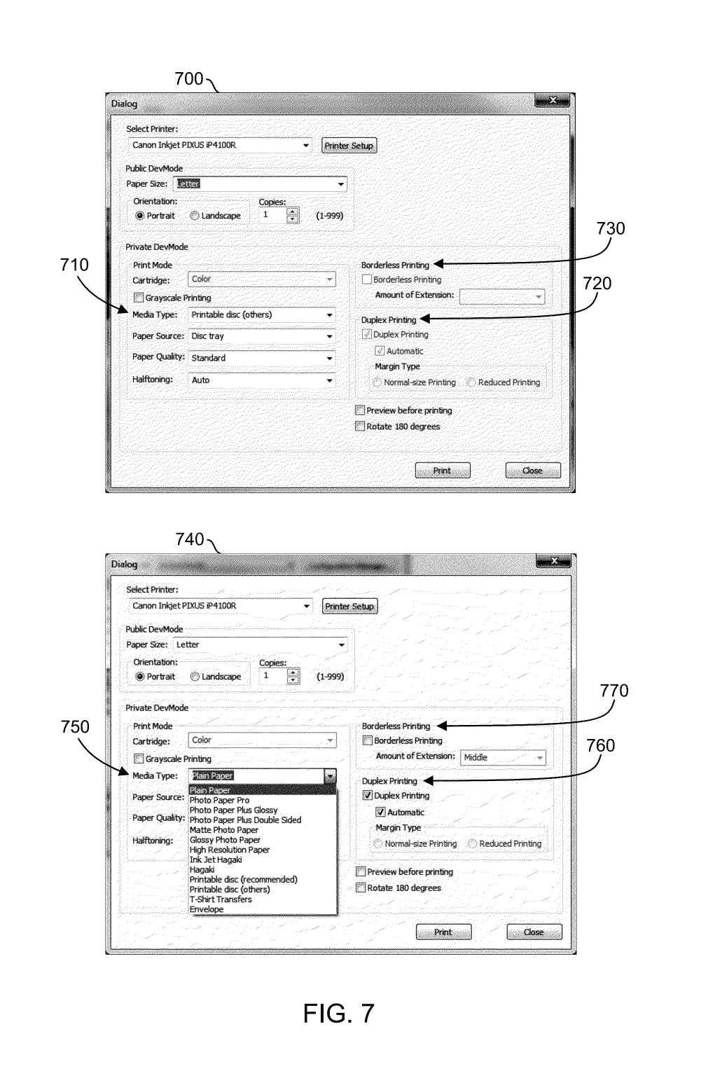

FIG. 7 illustrates example embodiments of user interfaces. A first user interface 700 shows that the option for the media type setting 710 has been set to Printable disc (others). The first user interface 700 also shows that the capabilities for the Duplex Printing setting 720 are grayed-out and the capabilities for the Borderless Printing setting 730 are grayed-out, and thus the capabilities for the Duplex Printing setting 720 and the Borderless Printing setting 730 are not available as selected options, and are constrained to be “off”. However, if a different option for the Media Type setting 710 is selected, at least some of the print capabilities change, as is shown the second user interface 740.

The second user interface 740 shows the selected option for the Media Type setting 750 has been set to Plain Paper. The second user interface 740 also shows that, for the Duplex Printing setting 760, the capabilities have changed to include the options Duplex Printing “on,” Duplex Printing “off,” automatic “on,” and automatic “off” (“on” and “off” being indicated by the check boxes). Thus, the Duplex Printing setting 760 is no longer constrained to “off”. Additionally, the capabilities of the Borderless Printing setting 770 have changed to include the options Borderless Printing “on” and Borderless Printing “off”, and thus the Borderless Printing setting is no longer constrained to “off”.

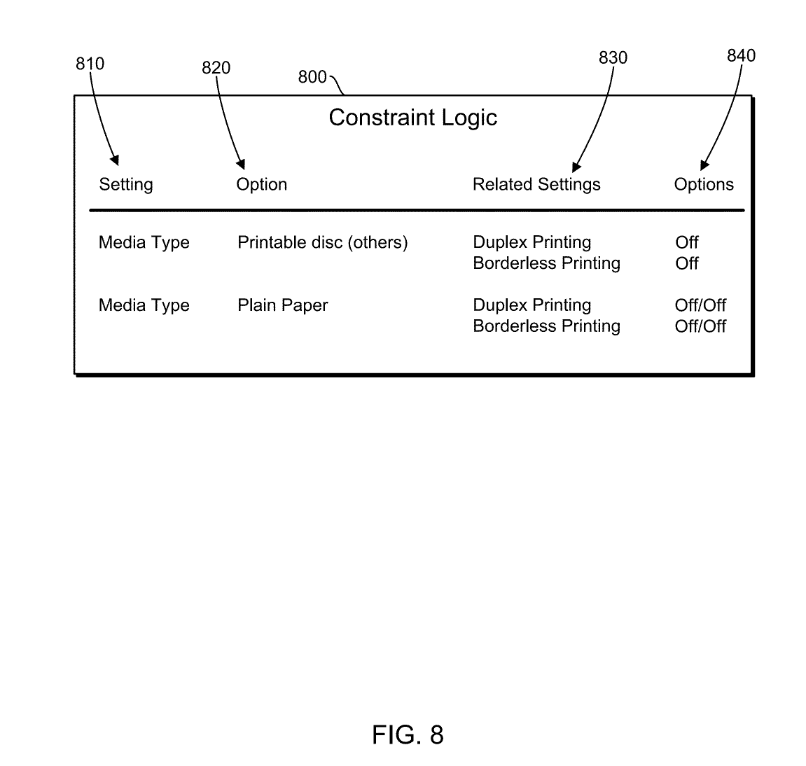

FIG. 8 illustrates an example embodiment of a constraint logic entry 800. The constraint logic entry 800 includes print settings 810 and associated options 820. Additionally, the constraint logic entry 800 includes related settings 830 that are related to respective associated options 820. The options 840 of the related settings 830 indicate which options of the related settings 830 are available to be selected and the options that are constrained when the print setting 810 is set to the associated option 820. In this embodiment, the constraint logic entry 800 shows that if printable disc (others) is the selected option for the media type print setting, the duplex printing setting if constrained to “off” and the borderless printing setting is constrained to “off”. The constraint logic entry 800 also shows that if plain paper is the selected option for the media type print setting, then the options “off” and “on” are available for both the duplex printing setting and the borderless printing setting.

The above described systems and methods can be achieved by supplying a storage medium having computer-executable instructions for realizing the above-described operations to one or more computing devices (e.g., CPU, MPU) that may read the computer-executable instructions stored in the storage medium and execute them. In this case, the computer-executable instructions when read from the storage medium and performed by the one or more computing devices execute the operations of the above described embodiments. Thus, the computer-executable instructions or the storage medium storing the computer-executable instructions therein constitute an embodiment.

Any applicable computer-readable storage medium (e.g., a magnetic disk (including a floppy disk, a hard disk), an optical disc (including a CD, a DVD, a Blu-ray disc), a magneto-optical disk, a magnetic tape, and a semiconductor device (including flash memory, a nonvolatile memory card, DRAM, SRAM, a solid state drive)) can be employed as a storage medium for the computer-executable instructions. The computer-executable instructions may be stored in a memory provided on a function-extension board inserted into the computing device or on a function-extension unit connected to the computing device, and a CPU provided on the function-extension board or unit may carry out part or all of the actual processing that realizes the operations of the above-described embodiments. Furthermore, when the computer-executable instructions are executed by the one or more computing devices, an operating system working on the computing system may carry out part or all of the actual processing that realizes the operations of the above described embodiments.

While the above disclosure describes certain illustrative embodiments, the invention is not limited to the above-described embodiments, and the following claims include various modifications and equivalent arrangements within their scope.

What is claimed is:

1. A method for printing, the method comprising:
receiving a request for print capabilities data from a computing device, wherein the request includes print settings data, and wherein the print settings data indicates a first imaging device associated with the print settings data;
generating print capabilities data based on the print settings data and on printing capabilities of the first imaging device;
adding imaging device capability constraint logic for the first imaging device to the print capabilities data; and
sending the print capabilities data to the computing device.

2. The method of claim 1, wherein the imaging device capability constraint logic defines relationships between print capabilities of the first imaging device.

3. The method of claim 2, wherein a relationship indicates interoperability of a first imaging device setting option with one or more other imaging device setting options.

4. The method of claim 1, wherein the imaging device capability constraint logic indicates an option of a first imaging device setting that may be used concurrently with one or more options of one or more other imaging device settings.

5. The method of claim 1, wherein the imaging device capability constraint logic indicates capabilities of a first imaging device setting that may be used concurrently with one more other imaging device capabilities.

6. The method of claim 1, wherein the computing device is a server.

7. The method of claim 6, further comprising:
receiving at the server updated print settings data; and
generating at the server updated print capabilities data based on the updated print settings data and the imaging device capability constraint logic.

8. The method of claim 1, wherein the computing device sends the request for a PrintCapabilities object to a proxy computing device, and the request for a PrintCapabilities object is received from the proxy computing device.

9. The method of claim 8, wherein the print capabilities data is sent to the proxy computing device, and the proxy computing device forwards the print capabilities data to the computing device.

10. One or more computer-readable media storing computer-executable instructions that, when executed by one or more computing devices, cause the one or more computing devices to perform operations comprising:
receiving print settings data for a first imaging device;
generating print capabilities data based on the print settings data and on print capabilities of the first imaging device; and
adding imaging device capability constraint logic for the first imaging device to the print capabilities data.

11. The one or more computer-readable media of claim 10, wherein the imaging device capability constraint logic defines relationships between print capabilities of the first imaging device.

12. The one or more computer-readable media of claim 10, wherein the imaging device capability constraint logic indicates an option of a first imaging device setting that may not be used concurrently with one or more options of one or more other imaging device settings.

13. The one or more computer-readable media of claim 10, wherein the imaging device capability constraint logic indicates capabilities of a first imaging device setting that may be used concurrently with capabilities of one more other imaging device settings.

14. The one or more computer-readable media of claim 10, wherein the application is disposed within a computing device separate from the one or more computing device.

15. The one or more computer-readable media of claim 14, wherein the operations further comprise:
sending the print capabilities data to an application;
receiving at the application updated print settings data; and
generating at the application updated print capabilities data based on the updated print settings data and on the imaging device capability constraint logic.

16. A computing device for updating print settings, the computing device comprising:
a computer-readable medium; and
one or more processors configured to cause the computing device to
receive print settings data for a print job for an imaging device;
generate print capabilities data for the print job based on the print settings data and print capabilities of the imaging device; and
add imaging device capability constraint logic to the print capabilities data, wherein the imaging device capability constraint logic indicates a relationship between print capabilities for a print setting and print capabilities for another print setting.

17. The computing device of claim 16, wherein the one or more processors are further configured to cause the computing device to send the print capabilities data, which includes the imaging device capability constraint logic, to a requesting application.

18. The computing device of claim 16, wherein the print capabilities data is formatted according to an XML format.

19. The computing device of claim 18, wherein the imaging device capability constraint logic is formatted as scripting code.
